(19) United States
(12) Patent Application Publication
(10) Pub. No.: US 2018/0367720 A1
(43) Pub. Date: Dec. 20, 2018

(54) DUAL CAMERA MODULE AND ELECTRONIC APPARATUS USING SAME

(71) Applicant: Primax Electronics Ltd., Taipei (TW)

(72) Inventors: CHUN-I LU, Taipei (TW); CHIUAN-HUNG LEE, Taipei (TW); CHING-FU WANG, Taipei (TW)

(21) Appl. No.: 15/815,011

(22) Filed: Nov. 16, 2017

(30) Foreign Application Priority Data
Jun. 16, 2017 (TW) 106120243

(51) Int. Cl. H04N 5/225

(52) U.S. Cl. CPC H04N 5/2258; H04N 5/2253

(57) ABSTRACT

The present invention provides a dual camera module. The dual camera module is applicable to an electronic apparatus and includes a first camera module and a second camera module, where the first camera module and the second camera module are disposed in a staggered manner, the first camera module is toward a first direction, the second camera module is toward a second direction, and the first direction is opposite to the second direction.

### FIELD OF THE INVENTION

The present invention relates to a camera module, and in particular, to a dual camera module that has a 360-degree panoramic photo shooting function.

### BACKGROUND OF THE INVENTION

As the Internet era emerges, people can communicate with each other by using an electronic apparatus through a wireless network whenever and wherever possible. An image capturing apparatus gradually becomes one of standard configurations of a current electronic apparatus. In addition to making a video call to perform face-to-face communication by using an electronic apparatus having an image capturing apparatus, people may photograph surrounding scenery or objects whenever and wherever possible, and share photos with their families or friends.

A common electronic apparatus is generally equipped with an image capturing apparatus of a dual-camera design. A camera on a same side as a control panel or keys is usually used for transmitting images during a video call. A camera on a side opposite to the control panel or the keys is usually used for taking photos. In addition, an electronic apparatus equipped with dual cameras may also be used for photographing a 360-degree panoramic image or a 3D image. In the prior art, for example, an electronic apparatus having a dual camera module is provided in the Taiwan Patent No. I312095. A substrate of the electronic apparatus is provided with a connection unit. The connection unit is configured to connect to a second camera. When any camera in the dual camera module is broken, the second camera only needs to be separated from the connection unit and the broken camera is replaced with a new camera, instead of replacing the entire dual camera module. Alternatively, for example, in the Chinese Patent No. CN105657099A, a dual camera module that can adjust a pupillary distance and whose first camera and second camera may be folded back-to-back is provided.

However, in the prior art, a first camera, a second camera, and a circuit board are overlapped in a dual camera module. Because of the back-to-back overlapping manner of the dual camera module, inner accommodation space of an electronic apparatus is occupied by the dual camera module, and consequently an overall structural design of the electronic is apparatus is affected. As a result, the overall volume or thickness of the electronic apparatus is increased and it is inconvenience for a user to carry the electronic apparatus. In addition, to provide the accommodation space for the dual camera module, an inner electronic circuit of the electronic apparatus may be configured less flexibly and freely.

In view of this, how to provide a dual camera module that requires smaller accommodation space is a technical problem to be resolved in the present invention.

### SUMMARY OF THE INVENTION

A main objective of the present invention is to provide a dual camera module that requires smaller accommodation space.

To achieve the foregoing objective, the present invention provides a dual camera module. The dual camera module is applicable to an electronic apparatus, and the dual camera module includes:
a first camera module; and
a second camera module, where
the first camera module and the second camera module are disposed in a staggered manner, the first camera module is toward a first direction, the second camera module is toward a second direction, and the first direction is opposite to the second direction.

In the foregoing preferred implementation, the electronic apparatus is: a notebook computer, a tablet computer, a personal digital assistant, a smartphone, or a game console.

In the foregoing preferred implementation, the dual camera module further includes a support, where the support is used for fixing the first camera module and the second camera module.

In the foregoing preferred implementation, the support includes a first support frame and a second support frame, the first support frame and the second support frame are formed as one structure by means of mutual combination, and the first support frame and the second support frame are in parallel with each other and there is a height difference between the two.

In the foregoing preferred implementation, the support includes a first support frame and a second support frame, the first support frame and the second support frame are integrally formed, and the first support frame and the second support frame are in parallel with each other and there is a height difference between the two.

In the foregoing preferred implementation, the support includes a first support frame and a second support frame, and the first support frame and the second support frame are integrally formed.

Another preferred implementation of the present invention relates to an electronic apparatus, including:
an enclosure;
a main circuit board; and
a dual camera module, disposed in the enclosure, and the dual camera module including a first camera module and a second camera module, where
the first camera module and the second camera module are disposed in a staggered manner, the first camera module is toward a first direction, the second camera module is toward a second direction, and the first direction is opposite to the second direction.

In the foregoing preferred implementation, the electronic apparatus is: a notebook computer, a tablet computer, a personal digital assistant, a smartphone, or a game console.

In the foregoing preferred implementation, the dual camera module further includes a support, where the support is used for fixing the first camera module and the second camera module.

In the foregoing preferred implementation, the support includes a first support frame and a second support frame, the first support frame and the second support frame are formed as one structure by means of mutual combination, and the first support frame and the second support frame are in parallel with each other and there is a height difference between the two.

In the foregoing preferred implementation, the support includes a first support frame and a second support frame, the first support frame and the second support frame are integrally formed, and the first support frame and the second support frame are in parallel with each other and there is a height difference between the two.

In the foregoing preferred implementation, the support includes a first support frame and a second support frame, and the first support frame and the second support frame are integrally formed.

### BRIEF DESCRIPTION OF THE DRAWINGS

FIG. 1A is a three-dimensional exploded view of a viewing angle of a camera module according to the present invention;

FIG. 1B is a three-dimensional exploded view of another viewing angle of a camera module according to the present invention;

FIG. 2A is a sectional view of a camera module according to the present invention;

FIG. 2B is a top view of a camera module according to the present invention;

FIG. 3A is a schematic three-dimensional diagram of a support according to a first embodiment of the present invention;

FIG. 3B is a schematic three-dimensional diagram of a support according to a second embodiment of the present invention;

FIG. 4A to FIG. 4C are schematic three-dimensional diagrams of assembly of a dual camera module according to the present invention;

FIG. 5 is a sectional view of a dual camera module according to the present invention; and

FIG. 6 is a schematic diagram of a dual camera module disposed in an electronic apparatus according to the present invention.

### DETAILED DESCRIPTION OF THE PREFERRED EMBODIMENT

The advantages and features of the present invention and the method for implementing the same are more readily understood with reference to the following more detailed description of exemplary embodiments and accompanying drawings. However, the present invention may be implemented in different forms, and should not be understood as being limited to the embodiments described herein. Rather, for a person of ordinary skill in the art, these embodiments are provided so that this disclosure will be more thorough and comprehensive, and will fully convey the concept of the present invention.

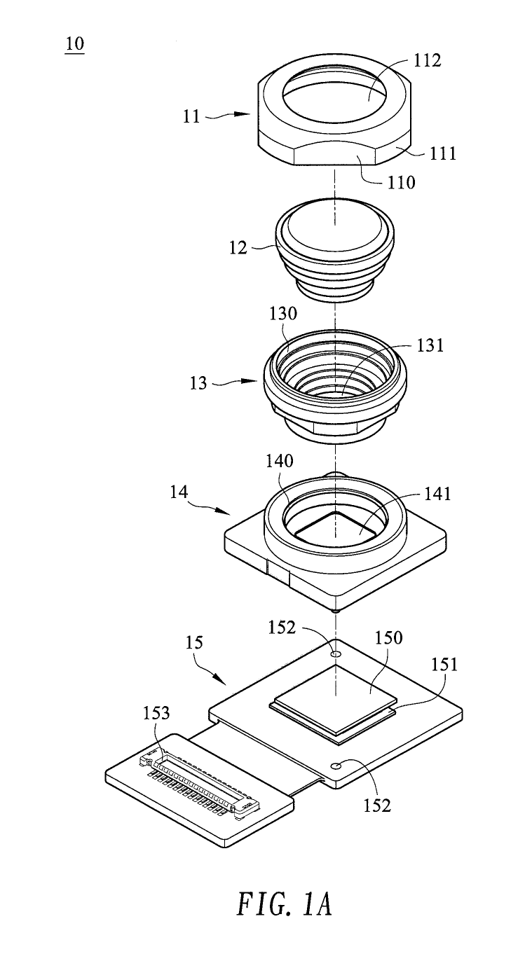

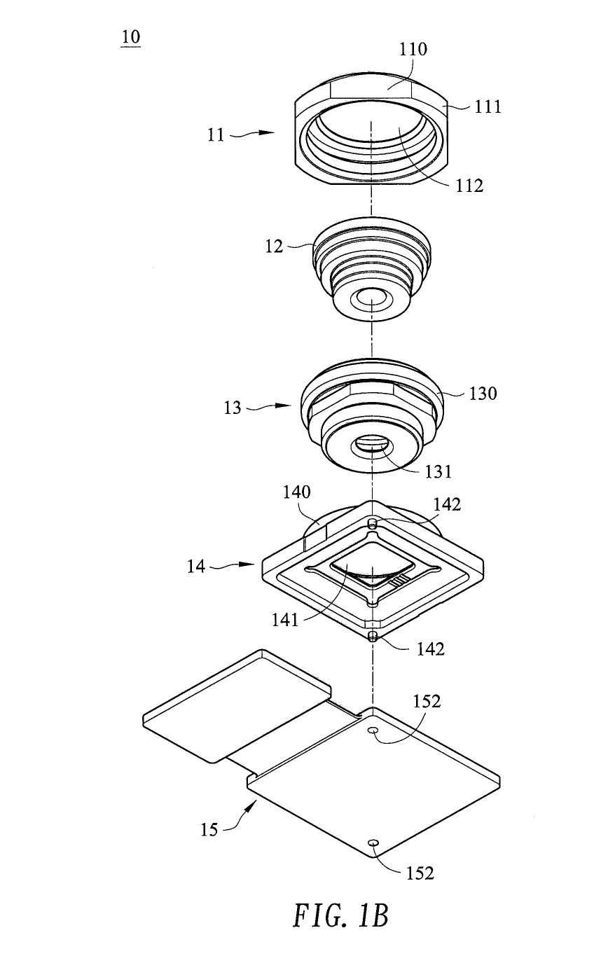

First, referring to FIG. 1A, FIG. 1A is a three-dimensional exploded view of a viewing angle of a camera module according to the present invention. In FIG. 1A, a first camera module 10 includes: a cover body 11, a lens assembly 12, a lens seat 13, a base 14, and a photosensitive element circuit board 15. The cover body 11 has a transparent opening 112 and four lateral faces 110, and there is an arc-shaped chamfer 111 between two adjacent lateral faces 110. The lens seat 13 has a lens seat groove 130 used for accommodating the lens assembly 12 and a first opening 131 located in a center of the lens seat groove 130. The base 14 has a base groove 140 used for accommodating and fixing the lens seat 13, and the center of the base groove 140 has a second opening 141. The photosensitive element circuit board 15 includes: a light filter 150, an electronic photosensitive element 151, positioning holes 152 provided in a peripheral diagonal positions of the electronic photosensitive element 151, and a connector 153. The electronic photosensitive element 151 may be a charge-coupled device (CCD) or a complementary metal-oxide-semiconductor (CMOS) active pixel sensor. The photosensitive element circuit board 15 may be a printed circuit board (PCB), a flexible PCB (FPCB), or a rigid-flex PCB.

Then, referring to FIG. 1B, FIG. 1B is a three-dimensional exploded view of another viewing angle of a camera module according to the present invention. In FIG. 1B, in a bottom of the base 14, there is a positioning rod 142 corresponding to the positioning hole 152 of the photosensitive element circuit board 15. The positioning rod 142 is used for passing through the positioning hole 152, so that the base 14 may be combined with the photosensitive element circuit board 15 by means of binding, buckling, or snap-fitting, and the second opening 141 of the base 14 may precisely correspond to a location of the electronic photosensitive element 151. Arrangement or a quantity of the positioning rod 142 may be adjusted according to a positioning requirement or a location or a quantity of the corresponding positioning holes 152. This is not limited to the implementations provided in the present invention.

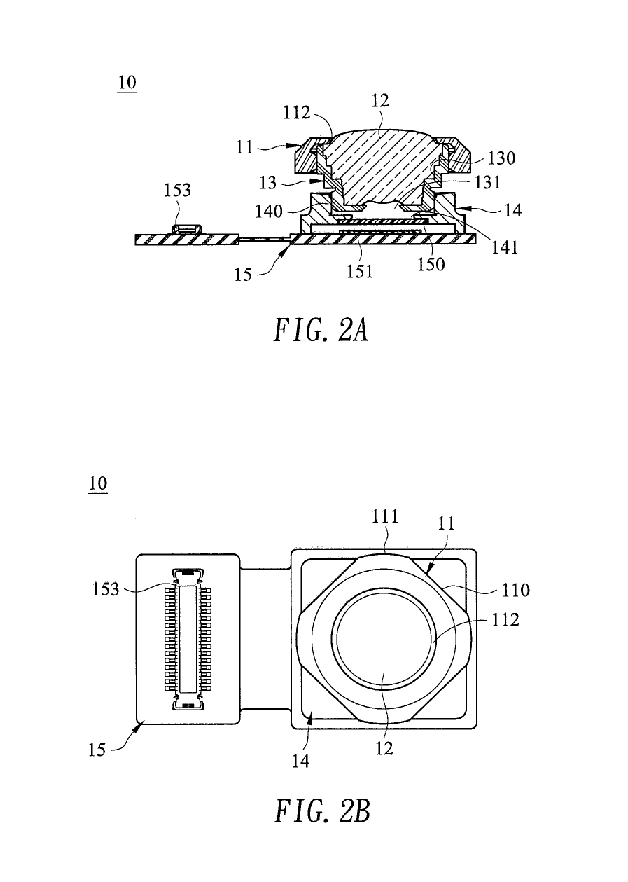

Referring to FIG. 2A, FIG. 2A is a sectional view of a camera module according to the present invention. In FIG. 2A, a lens seat groove 130 accommodates a lens assembly 12 and the lens assembly 12 is locked in the lens seat groove 130 by using a cover body 11. One end of the lens assembly 12 protrudes out of a transparent opening 112, and another end that is of the lens assembly 12 and that is opposite to the transparent opening 112 is adjacent to a first opening 131 of a lens seat 13. The lens seat 13 may be fixed in a base groove 140 by means of binding or locking, and a location of the first opening 131 of the lens seat 13 corresponds to a location of a second opening 141 of a base 14. A light filter 150 is adjacent to the second opening 141 of the base 14 by means of binding or buckling. When an environmental image is captured by using a first camera module 10, light rays of a surrounding environment may enter from the transparent opening 112, and traveling directions of the light rays are corrected by using the lens assembly 12. Then, the light rays are cast to an electronic photosensitive element 151 by passing through the first opening 131, the second opening 141, and the light filter 150. The electronic photosensitive element 151 converts the to received optical image into an electronic signal and outputs the electronic signal by using a connector 153.

Referring to FIG. 2B, FIG. 2B is a top view of a camera module according to the present invention. In FIG. 2B, an end of a lens assembly 12 of a first camera module 10 that is fully assembled protrudes out of a transparent opening 112 of a cover body 11. The cover body 11 has four lateral faces 110 and an arc-shaped chamfer 111 between two adjacent lateral faces 110. A base 14 is combined with a photosensitive element circuit board 15, and a connector 153 used for outputting an electronic signal is disposed on a surface of the photosensitive element circuit board 15.

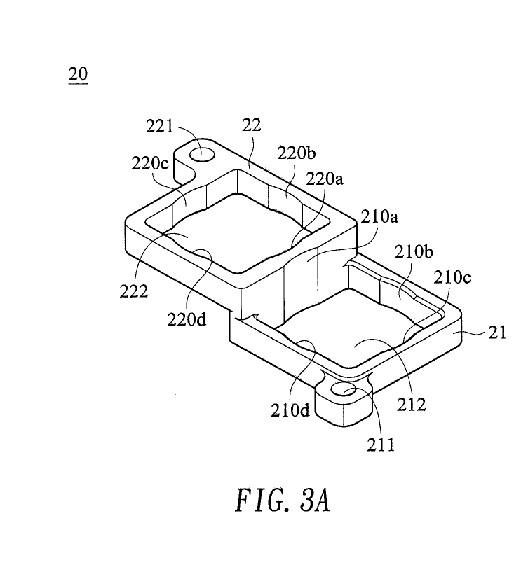

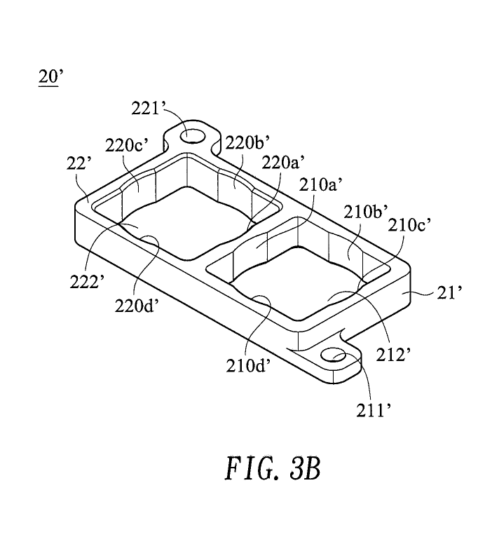

Referring to FIG. 3A, FIG. 3A is a schematic three-dimensional diagram of a support according to a first embodiment of the present invention. In FIG. 3A, a support 20 used for fixing a camera module includes a first support frame 21 and a second support frame 22. The first support frame 21 and the second support frame 22 may be formed as one structure by means of mutual combination. For example, the second support frame 22 may be stacked on the first support frame 21. Then, the first support frame 21 and the second support frame 22 are formed as one structure by means of mutual combination in a manner of buckling or binding. Alternatively, the support 20 may be integrally formed. In addition, the first support frame 21 and the second support frame 22 are in parallel with each other and there is a height difference between the two. The first support frame 21 has a first locking portion 211 and a first opening 212, and on an inner side wall of a frame of the first opening 212, there are guide grooves 210a, 210b, 210c, and 210d corresponding to arc-shaped chamfers 111 (as shown in FIG. 2B) of a cover body 11. The guide grooves 210a, 210b, 210c, and 210d are used for avoiding interference with the arc-shaped chamfers 111 of the cover body 11. In addition, the guide grooves 210a, 210b, 210c, and 210d may guide a first camera module 10 to enter the first opening 212 in a correct direction. The guide groove 210a extends from the inner side wall of the frame of the first opening 212 to an outer side wall of the second support frame 22. The second support frame 22 has a second locking portion 221 and a second opening 222, and on an inner side wall of a frame of the second opening 222, there are guide grooves 220a, 220b, 220c, and 220d corresponding to the arc-shaped chamfers 111 (as shown in FIG. 2B) of the cover body 11. The guide grooves 220a, 220b, 220c, and 220d may also be used for avoiding interference with arc-shaped chamfers of another camera module, and may guide the another camera module to enter the second opening 222 in a correct direction. The guide groove 220a extends from an inner side wall of a frame of the second opening 222 to an outer side wall of the first support frame 21 (not shown). Although the present invention provides implementations that four guide grooves are designed on an inner side wall of a frame, during actual application, adjustment may be made according to a design of a cover body of a camera module. However, if the cover body of the camera module does not interfere with the frame, no guide groove needs to be provided on the inner side wall of the frame.

Referring to FIG. 3B, FIG. 3B is a schematic three-dimensional diagram of a support according to a second embodiment of the present invention. In FIG. 3B, a support 20′ is integrally formed and does not has a height difference. The support 20′ includes a first support frame 21′ and a second support frame 22′. The first support frame 21′ has a first locking portion 211′ and a first opening 212′, and on an inner side wall of a frame of the first opening 212′, there are guide grooves 210a′, 210b′, 210c′, and 210d′ corresponding to arc-shaped chamfers 111 (as shown in FIG. 2B) of a cover body 11. The guide grooves 210a′, 210b′, 210c′, and 210d′ are used for avoiding interference with the arc-shaped chamfers 111 of the cover body 11. In addition, the guide grooves 210a′, 210b′, 210c′, and 210d′ may guide a first camera module 10 to enter the first opening 212′ in a correct direction. The second support frame 22′ has a second locking portion 221′ and a second opening 222′, and on an inner side wall of a frame of the second opening 222′, there are guide grooves 220a′, 220b′, 220c′, and 220d′ corresponding to the arc-shaped chamfers 111 (as shown in FIG. 2B) of the cover body 11. The guide grooves 220a′, 220b′, 220c′, and 220d′ may also be used for avoiding interference with arc-shaped chamfers of another camera module, and may guide the another camera module to enter the second opening 222′ in a correct direction.

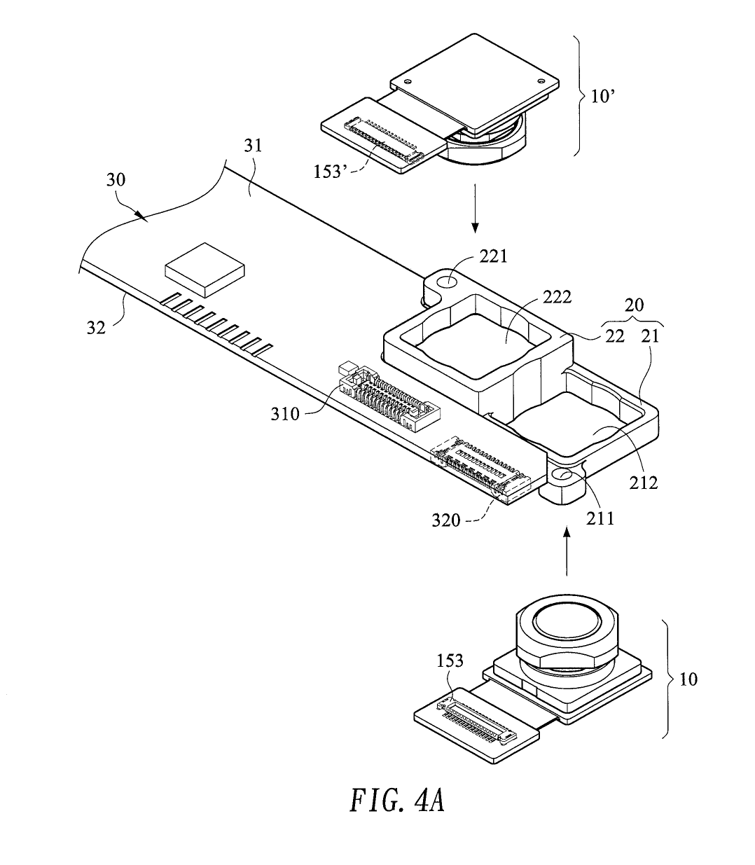

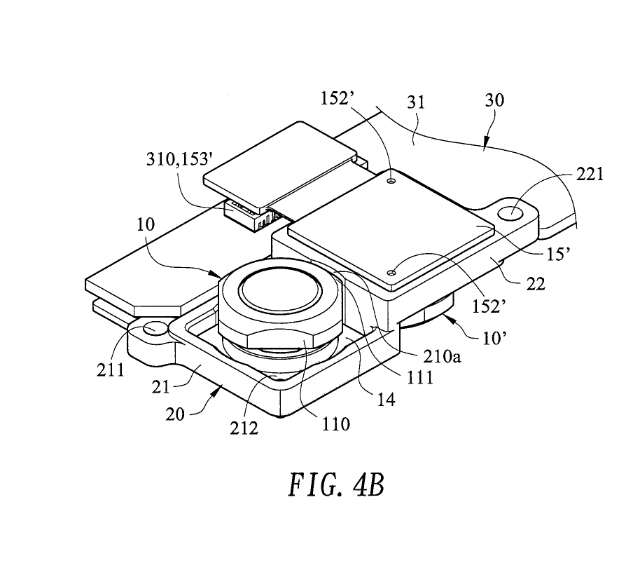

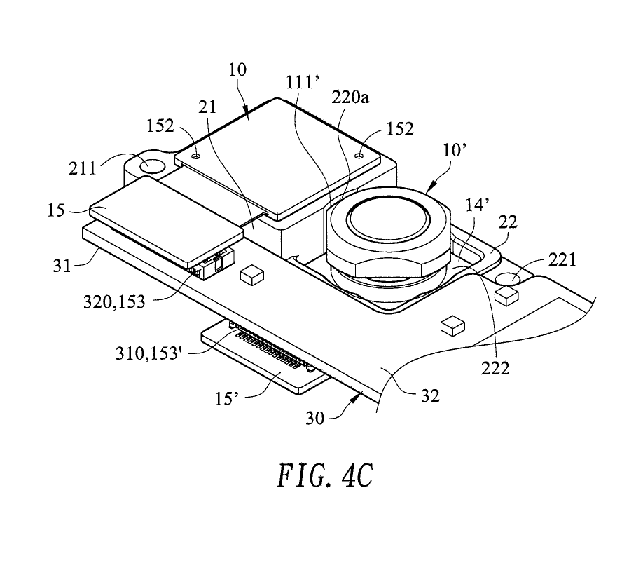

Referring to FIG. 4A to FIG. 4C, FIG. 4A to FIG. 4C are schematic three-dimensional diagrams of assembly of a dual camera module according to the present invention. In FIG. 4A, the dual camera module includes a first camera module 10 and a second camera module 10′. Components included in the second camera module 10′ are the same as that included in the first camera module 10, and details are not described herein again. A support 20 having a height difference uses a first locking portion 211 and a second locking portion 221 to lock the support 20 on an enclosure (not shown) of an electronic apparatus or lock the support 20 on a main circuit board 30 of the electronic apparatus, so that the support 20 may be fixed on one side of the main circuit board 30. Alternatively, the support 20 may be replaced with a support 20′ (as shown in FIG. 3B) not having a height difference. The main circuit board 30 has a first surface 31 and a second surface 32. The first surface 31 and the second surface 32 respectively have a port 310 and a port 320. Alternatively, the main circuit board 30 may be a PCB, an FPCB, or a rigid-flex PCB.

Still referring to FIG. 4A, the first camera module 10 is disposed and fixed on a first opening 212 of a first support frame 21, and a connector 153 is used for being plugged into the port 320 on the second surface 32 of the main circuit board 30, so that the first camera module 10 and the main circuit board 30 are electrically connected. The second camera module 10′ is disposed and fixed on the first opening 222 of the second support frame 22, and a connector 153′ of the second camera module 10′ is plugged into the port 310 on the first surface 31 of the main circuit board 30, so that the second camera module 10′ and the main circuit board 30 are electrically connected.

Then, referring to FIG. 4B, after the first camera module 10 passes through the first opening 212 of the first support frame 21, a base 14 of the first camera module 10 may be combined with the first support frame 21 by means of adhesive binding, tightly pressing, or the like. An arc-shaped chamfer 111 of a cover body 11 presses against a guide groove 210a. Still referring to FIG. 4C, after the second camera module 10′ passes through the second opening 222 of the second support frame 22, a base 14′ of the second camera module 10′ may be combined with the second support frame 22 by means of adhesive binding, tightly pressing, or the like, and an arc-shaped chamfer 111′ of a cover body 11′ presses against a guide groove 220a. The connector 153 of the first camera module 10 is plugged into the port 320 on the second surface 32 of the main circuit board 30, and the connector 153′ of the second camera module 10′ is plugged into the port 310 on the first surface 31 of the main circuit board 30. Although only implementations that a base is combined with a support frame by means of adhesive binding, tightly pressing, or the like are provided in the present invention, during actual application, the base may also be combined with the support frame by means of buckling, snap-fitting, locking, or the like. This is not limited to the implementations such as adhesive binding or tightly pressing.

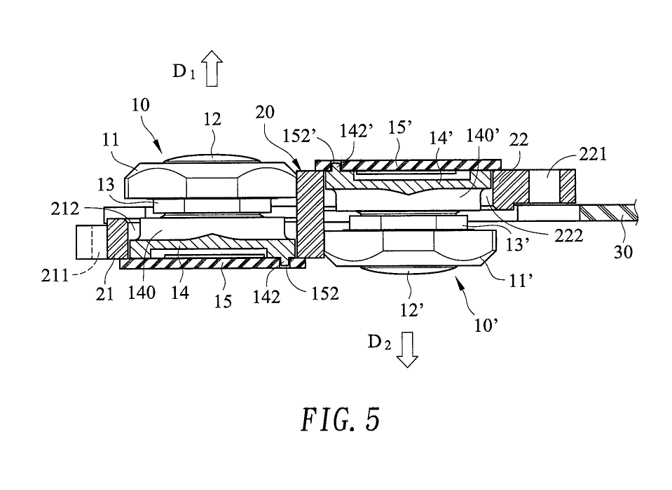

Referring to FIG. 5, FIG. 5 is a sectional view of a dual camera module according to the present invention. A base 14 of a first camera module 10 is combined with a first support frame 21, so that the first camera module 10 may be stably fixed in a first opening 212. The first camera module 10 is toward a first direction D1. A base 14′ of a second camera module 10′ is combined with a second support frame 22, so that the second camera module 10′ may be stably fixed in a second opening 222. The second camera module 10′ is toward a second direction D2, and the first direction D1 is opposite to the second direction D2. In this way, an image may be captured by using the first camera module 10 or the second camera module 10′. Then, the captured optical image is converted into an electronic signal, and the electronic signal is output from a connector 153 or a connector 153′. Alternatively, the first camera module 10 and the second camera module 10′ respectively capture at the same time an environmental image greater than 180 degrees, convert the environmental images into electronic signals, and output the electronic signals to the main circuit board 30 from the connector 153 or the connector 153′. Then, image processing is performed on the electronic signals by using an image signal processor (ISP) (not shown) or a digital signal processor (DSP) (not shown) disposed on the main circuit board 30, and image stitching of post-processing is performed by means of the image processing, so that a panoramic image of 360 degrees may be obtained. Because the main circuit board 30 is provided with an ISP and a DSP, image processing efficiency may be effectively improved.

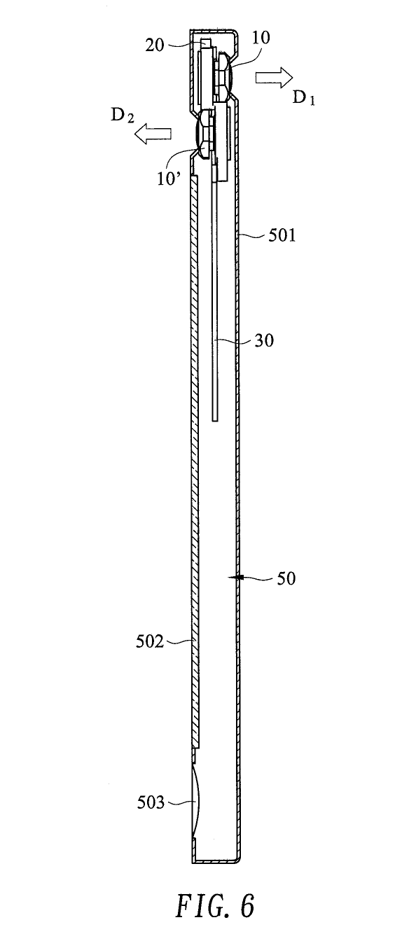

Referring to FIG. 6, FIG. 6 is a schematic diagram of a dual camera module disposed in an electronic apparatus according to the present invention. An electronic apparatus 50 is a smartphone. The smartphone includes: an enclosure 501, a touch panel 502, keys 503, a first camera module 10 that is toward a first direction D1, a second camera module 10′ that is toward a second direction D2, a support 20, and a main circuit board 30. Because the first camera module 10 and the second camera module 10′ are disposed in a staggered manner, accommodation space required for disposing the dual camera module may be reduced. Therefore, the overall volume or thickness of the electronic apparatus 50 can be effectively reduced, and an inner electronic circuit of the electronic apparatus 50 can be configured more flexibly and freely. Although only an implementation that the electronic apparatus 50 is a smartphone is provided in the present invention, during actual application, the dual camera module provided in the present invention may also be applied to a notebook computer, a tablet computer, a personal digital assistant, a game console, or an electronic apparatus having an image capturing function. This is not limited to the implementations provided in the present invention.

Compared with the prior art, in the present invention, a first camera module and a second camera module in a dual camera module are disposed in a staggered manner, so that accommodation space required for disposing the dual camera module can be greatly reduced. Therefore, the overall volume or thickness of an electronic apparatus can be effectively reduced, and an inner electronic circuit of the electronic apparatus can be configured more flexibly and freely. In addition, because the dual camera module is disposed in a support, when any camera module in the dual camera module is broken, only the broken camera module needs to be removed from the support and is replaced with a new camera module. Alternatively, when any camera module in the dual camera module is broken and the support is formed by means of structural combination, two support frames of the support may be separated, and then the broken camera module and a support frame to which the broken camera module is fixed are removed and are respectively replaced with a new camera module and a new support frame. Therefore, the entire dual camera module or the main circuit board does not need to be replaced. Therefore, the present invention is essentially of high industrial value.

Any modification to the present invention readily figured out by a person skilled in the art shall fall within the protection scope of the appended claims.

1. A dual camera module, wherein the dual camera module is applicable to an electronic apparatus, and the dual camera module comprises:
a first camera module; and
a second camera module, wherein
the first camera module and the second camera module are disposed in a staggered manner, the first camera module is toward a first direction, the second camera module is toward a second direction, and the first direction is opposite to the second direction; wherein the dual camera module further comprises a support for fixing the first camera module and the second camera module, and wherein the support comprises a first support frame and a second support frame and the first support frame comprises a first opening for receiving the first camera module therein and the second support frame comprises a second opening for receiving the second camera module therein.

2. The dual camera module according to claim 1, wherein the electronic apparatus is: a notebook computer, a tablet computer, a personal digital assistant, a smartphone, or a game console.

3. (canceled)

4. The dual camera module according to claim 2, wherein the first support frame and the second support frame are formed as one structure by means of mutual combination, and the first support frame and the second support frame are in parallel with each other and there is a height difference between the two.

5. The dual camera module according to claim 2, wherein the first support frame and the second support frame are integrally formed, and the first support frame and the second support frame are in parallel with each other and there is a height difference between the two.

6. The dual camera module according to claim 2, wherein the first support frame and the second support frame are integrally formed.

7. An electronic apparatus, wherein the electronic apparatus comprises:
an enclosure;
a main circuit board; and
a dual camera module, disposed in the enclosure, and the dual camera module comprising a first camera module and a second camera module, wherein
the first camera module and the second camera module are disposed in a staggered manner, the first camera module is toward a first direction, the second camera module is toward a second direction, and the first direction is opposite to the second direction; wherein the dual camera module further comprises a support for fixing the first camera module and the second camera module, and wherein the support comprises a first support frame and a second support frame and the first support frame comprises a first opening for receiving the first camera module therein and the second support frame comprises a second opening for receiving the second camera module therein.

8. The electronic apparatus according to claim 7, wherein the electronic apparatus is: a notebook computer, a tablet computer, a personal digital assistant, a smartphone, or a game console.

9. (canceled)

10. The electronic apparatus according to claim 8, wherein the first support frame and the second support frame are formed as one structure by means of mutual combination, and the first support frame and the second support frame are in parallel with each other and there is a height difference between the two.

11. The electronic apparatus according to claim 8, wherein the first support frame and the second support frame are integrally formed, and the first support frame and the second support frame are in parallel with each other and there is a height difference between the two.

12. The electronic apparatus according to claim 8, wherein the first support frame and the second support frame are integrally formed.
